(19) United States
(12) Patent Application Publication
(10) Pub. No.: US 2025/0307949 A1
(43) Pub. Date: Oct. 2, 2025

(54) SYSTEM AND METHODS FOR REAL-TIME PROCESSING OF ACCOUNT OPERATIONS OF A RESOURCE ACCOUNT

(71) Applicant: The Toronto-Dominion Bank, Toronto (CA)

(72) Inventor: James Charles FRANK, Denver, NC (US)

(73) Assignee: The Toronto-Dominion Bank, Toronto, ON (CA)

(21) Appl. No.: 18/617,068

(22) Filed: Mar. 26, 2024

(51) Int. Cl. G06Q 40/12

(52) U.S. Cl. CPC G06Q 40/12

(57) ABSTRACT

A computer-implemented method is disclosed. The method includes: determining at least one trigger condition associated with a resource account; detecting the at least one trigger condition based on real-time analysis of resource transfers in connection the resource account; determining a set of actions based on the resource transfer data, the at least one trigger condition, and customer information; generating text prompts for a large language model to obtain recommendations output for the customer in connection with one or more of the actions of the determined set; obtaining customer input of responses to the recommendations data; and submitting requests, via API calls, to one or more third-party service providers in order to perform the one or more actions, the API calls being generated based on the customer-inputted responses.

### TECHNICAL FIELD

The present application relates to resource management and, more particularly, to a system and methods for real-time processing of account operations for resource accounts in a networked computing environment.

### BACKGROUND

Generative artificial intelligence (AI) models are increasingly being used across many domains. Such models (e.g., large language models, or LLMs) can be used to generate responses conditioned on input of natural language prompts. For example, AI-based chatbots are widely used to understand user questions/requests and automate responses to them. These chatbots employ natural language understanding to discern the user's needs based on their chat interactions. It is desired to provide technologies for managing user data, such as account information of user accounts, that leverage generative AI for automating analysis and processing data-driven computing operations.

### BRIEF DESCRIPTION OF THE DRAWINGS

Reference will now be made, by way of example, to the accompanying drawings which show example embodiments of the present application and in which:

FIG. 1 is a schematic diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 shows, in flowchart form, an example method for processing account operations of a resource account;

FIG. 4 shows, in flowchart form, an example method for processing computing operations that are driven by detected account activity of a resource account;

FIG. 5 shows, in flowchart form, an example method for operating a virtual assistant application to process computing operations that are driven by detected account activity of a resource account; and

FIG. 6 shows, in flowchart form, an example method for converting account activity data of a resource account to executable computing operations.

Like reference numerals are used in the drawings to denote like elements and features.

### DETAILED DESCRIPTION OF EXAMPLE EMBODIMENTS

In an aspect, a computing system is disclosed. The computing system includes a processor and a memory coupled to the processor. The memory stores instructions that, when executed by the processor, may cause the processor to: determine at least one trigger condition associated with a resource account; detect the at least one trigger condition based on real-time analysis of resource transfers in connection the resource account; determine a set of actions based on the resource transfer data, the at least one trigger condition, and customer information; generate text prompts for a large language model to obtain recommendations output for the customer in connection with one or more of the actions of the determined set; obtain customer input of responses to the recommendations data; and submit requests, via API calls, to one or more third-party service providers in order to perform the one or more actions, the API calls being generated based on the customer-inputted responses.

In some implementations, the at least one trigger condition may relate to a quantity of resources that are allocated to a user-defined goal for the resource account.

In some implementations, the instructions, when executed, may further configure the processor to receive user input of an indication of the user-defined goal and a first quantity of resources of the resource account for allocating to the goal.

In some implementations, the customer information may comprise at least one of profile information, personal preference data, or indications of budgeting patterns and spending behaviors.

In some implementations, the set of actions may include at least one of: obtaining itinerary or reservations data from a data store; obtaining product reviews data from a data store; or completing reservations on one or more third-party service provider platforms.

In some implementations, detecting the at least one trigger condition may include: obtaining historical transactions data associated with the resource account; and determining that a first user-defined goal has been achieved based on the historical transactions data.

In some implementations, the instructions, when executed, may further configure the processor to parse the historical transactions data and identify one or more resource transfers that relate to the first user-defined goal.

In some implementations, the customer-inputted responses may comprise at least selections of one or more desired itinerary items, and the instructions, when executed, may further configure the processor to initiate reservations using the selected one or more itinerary items.

In some implementations, the instructions, when executed, may further configure the processor to determine that completion of a first user-defined goal is imminent based on historical transactions data associated with the resource account; and generate notifications for alerting a user associated with the resource account regarding the imminent completion.

In some implementations, determining that completion of the first user-defined goal is imminent may include detecting proximity to at least one of a user-inputted defined date or quantity of allocated resources.

In another aspect, a computer-implemented method is disclosed. The method may include: determining at least one trigger condition associated with a resource account; detecting the at least one trigger condition based on real-time analysis of resource transfers in connection the resource account; determining a set of actions based on the resource transfer data, the at least one trigger condition, and customer information; generating text prompts for a large language model to obtain recommendations output for the customer in connection with one or more of the actions of the determined set; obtaining customer input of responses to the recommendations data; and submitting requests, via API calls, to one or more third-party service providers in order to perform the one or more actions, the API calls being generated based on the customer-inputted responses.

In another aspect, a non-transitory computer readable storage medium is disclosed. The computer readable storage medium stores computer-executable instructions that, when executed by a processor, may cause the processor to: determine at least one trigger condition associated with a resource account; detect the at least one trigger condition based on real-time analysis of resource transfers in connection the resource account; determine a set of actions based on the resource transfer data, the at least one trigger condition, and customer information; generate text prompts for a large language model to obtain recommendations output for the customer in connection with one or more of the actions of the determined set; obtain customer input of responses to the recommendations data; and submit requests, via API calls, to one or more third-party service providers in order to perform the one or more actions, the API calls being generated based on the customer-inputted responses.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, the term “generative AI model” (or simply “generative model”) may be used to describe a machine learning model. A generative AI model may sometimes be referred to, or may use, a language model. A trained generative AI model may respond to an input prompt by generating and producing an output or result. The output/result may be produced by the generative AI model through interpreting the intent and context of the input prompt. In some cases, the generative AI model may be implemented with constraints on the acceptable input prompts. The constraints may, for example, be defined using one or more prompt templates. A prompt template may specify that input prompts have certain structure or constrained intents, or that acceptable prompts exclude certain classes of subject matter or intent, such as the production of results/outputs that are violent, obscene, etc.

Resource account owners often define various conditions to monitor in connection with their accounts. Such conditions may be formed as goals, (maximum or minimum) thresholds, etc., associated with use or allocation of the resources of an account. The definition of a condition may specify certain actions which are to be triggered upon detecting that the condition is satisfied. In certain contexts, the defined conditions for a resource account may not be regularly monitored by the account owner. In particular, account owners may not monitor their account activities on a sufficiently frequent basis in order to ascertain whether one or more of the conditions have been satisfied. For example, a resource account that undergoes a high volume of resource transfers in a short span of time poses a challenge for the account owner to detect the defined conditions in real-time. This may result in missed or delayed account actions or, in some instances, the account owner unwittingly misallocating resources in a manner that detracts from reaching certain conditions.

The present application discloses an artificial intelligence (AI)-based virtual assistant equipped for monitoring account activity of resource accounts and actioning on user-defined trigger conditions associated with the resource accounts. The virtual assistant may be implemented as a software layer between account data of user accounts and a large language model (LLM)-based chatbot, such as ChatGPT.

An account owner may define one or more specific triggers, such as financial goals or milestones, in connection with their bank account. The financial goals may, for example, comprise savings goals (e.g., saving for vacations, or other large purchases) or personal budgets. The customer may define rules for allocating certain funds from their bank account toward their financial goals.

The virtual assistant is configured to monitor real-time and historical transactions data of the customer for detecting customer-defined triggers. More particularly, the virtual assistant obtains account data of the customer's bank account in real-time and determines whether any one of the defined goals is met. In at least some implementations, the virtual assistant may analyze the transactions data or use contextual information in order to identify relevant goals for which the customer should be prompted. By way of example, the virtual assistant can determine when certain goals are close to being met based on one or more detected transactions (e.g., account deposits). As another example, the virtual assistant may parse transactions information to determine that the customer has made certain purchases relating to a defined experience or event (e.g., vacation). As yet another example, the virtual assistant may use information inputted by the customer as part of the definition of their financial goals in generating alerts relating to certain goals based on proximity of date, etc.

Once a trigger (e.g., reaching a savings goal) is detected, the virtual assistant determines one or more actions that need to be performed via third-party service providers. That is, for a detected goal, the virtual assistant may identify actions for enabling the goal to be achieved. The actions may comprise tasks that the virtual assistant can initiate using the goal and customer data. For example, a savings goal relating to a vacation may require various bookings for flights, hotels, etc. The virtual assistant may determine the required tasks, such as activities and itinerary research, reservations, etc., and perform, or caused to be performed, the tasks in a suitable order. In at least some implementations, the virtual assistant may submit requests, via API calls, to the third-party service providers in order to obtain data relevant for performing the tasks (e.g., flight times, etc.) and/or to directly initiate the tasks (e.g., making a reservation).

As part of performing the required tasks for the detected goal, the virtual assistant generates text prompts for an LLM-based chatbot (e.g., ChatGPT). The text prompts are generated based on the obtained transactions data, the set of actions determined for the detected trigger, and customer information (e.g., profile information, personal preference data, budgeting patterns, spending behaviors, etc.). The chat output may comprise recommendations for the customer and/or set of options that the customer would be prompted to select from. The recommendations/options are presented to the customer. Upon receiving a response from the customer, such as selections of desired itinerary items or details, the virtual assistant is configured to automatically perform actions to finalize the related bookings.

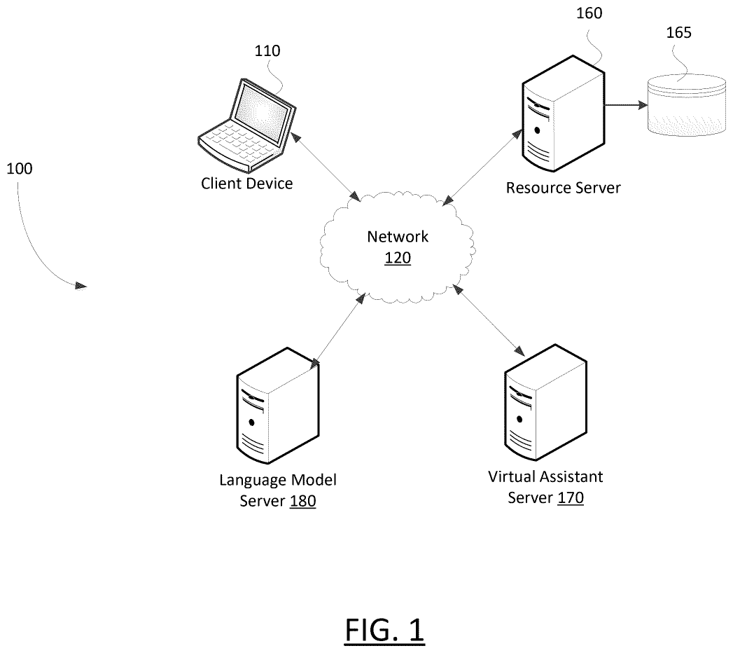

Reference is first made to FIG. 1 which illustrates an example networked environment 100 consistent with certain disclosed embodiments. As shown in FIG. 1, the networked environment 100 may include client devices 110, a resource server 160, a database 165 associated with the resource server 160, a virtual assistant server 170, a language model server 180, and a communications network 120 connecting various components of the networked environment 100.

The resource server 160 (which may also be referred to as a server computer system) and the client devices 110 communicate via the network 120. In at least some implementations, the client device 110 is a computing device. The client device 110 may take a variety of forms including, for example, a mobile communication device such as a smartphone, a tablet computer, a wearable computer such as a head-mounted display or smartwatch, a laptop or desktop computer, or a computing device of another type. The client device 110 is associated with a client entity (e.g., an individual, an organization, etc.) having resources that are managed by, or using, the resource server 160. For example, the resource server 160 may be a financial institution server and the client entity may be a customer of a financial institution that operates the financial institution server. The client device 110 may store software instructions that cause the client device to establish communications with the resource server 160.

The resource server 160 may be configured to track, manage, and maintain resources, make lending decisions, and/or lend resources to a client entity associated with the client device 110. The resources may, for example, comprise computing resources, such as memory or processor cycles. In at least some implementations, the resources may include stored value, such as fiat currency, which may be represented in a database. For example, the resource server 160 may be coupled to a database 165, which may be provided in secure storage. The secure storage may be provided internally within the resource server 160 or externally. The secure storage may, for example, be provided remotely from the resource server 160. For example, the secure storage may include one or more data centers storing data with bank-grade security.

The database 165 may include records for a plurality of accounts and at least some of the records may define a quantity of resources associated with the client entity. For example, the client entity may be associated with an account having one or more records in the database 165. The records may reflect a quantity of stored resources that are associated with the client entity. Such resources may include owned resources and, in some implementations, borrowed resources (e.g., resources available on credit). The quantity of resources that are available to or associated with the client entity may be reflected by a balance defined in an associated record such as, for example, a bank account balance.

In some implementations, the database 165 may store various types of information relating to customers of a business entity that administers the resource server 160. For example, the database 165 may store customer profile data and financial account data associated with customers. The customer profile data may include, without limitation, personal information of registered customers, authentication credentials of the customers, account identifying information (e.g., checking and/or savings account numbers), and information identifying the services (e.g., banking services, investment management services, etc.) and programs that are offered to the customers by the business entity. The financial account data may include portfolio data relating to portfolios of investments that are held by customers. A customer's portfolio data may include, for example, information identifying actual positions held by the customer in various securities, information identifying a “virtual” portfolio composed of simulated positions held by the customer in various securities, and “watch lists” specifying various securities that are monitored by the customer.

The client device 110 may be used, for example, to configure data transfers from an account associated with the client device 110. More particularly, the client device 110 may be used to configure data transfers from an account associated with an entity operating the client device 110. The data transfer may involve a transfer of data between a record in the database 165 associated with such an account and another record in the database 165 (or in another database such as a database associated with another server (not shown) which may be provided by another financial institution, for example, and which may be coupled to the resource server 160 via a network). The other record is associated with a data transfer recipient such as, for example, a bill payment recipient. The data involved in the transfer may, for example, be units of value and the records involved in the data transfer may be adjusted in related or corresponding manners. For example, during a data transfer, a record associated with the data transfer recipient may be adjusted to reflect an increase in value due to the transfer whereas the record associated with the entity initiating the data transfer may be adjusted to reflect a decrease in value which is at least as large as the increase in value applied to the record associated with the data transfer recipient.

The client device 110 is configured to receive user input of various information. In particular, a user may input information relating to various operations that are desired to be managed using the client device 110. For example, one or more applications on the client device 110 may allow the user to indicate details about operations associated with the user and quantities of resources allocated to said operations. In some embodiments, the operations may be device operations that are desired to be performed on the client device 110. For example, the user may specify how much computing resources should be allocated to various software applications, and background services that are running on the client device 110. A job scheduler application (or application programming interface, API) may be used for selecting operations, allocating resources to the operations, and automating the operations on the client device 110. Accordingly, the client device 110 may receive input of, among others, job or task identifiers, scheduled time of execution of job, and quantities of computing resources (e.g. network bandwidth, processing power, memory, etc.) allocated to the jobs.

In some embodiments, the operations may be specific tasks or objectives associated with the user. In particular, the client device 110 may be used to manage personal activities and goals of a user (or other entity). For example, a personal financial management (PFM) application may be provided on the client device 110, providing the user with various functionalities relating to financial management. The PFM application may facilitate, for example, tracking personal expenses, cost splitting, scheduling debt payments, automated investments, and creating and monitoring personal budgets. Accordingly, the client device 110 may receive input of, among others, personal finance information, definitions of goals or budgets, and payee information.

The virtual assistant server 170 is associated with an AI-based virtual assistant. The virtual assistant server 170 may comprise one or more computing devices that are configured to perform operations consistent with providing a virtual assistant operable on client computing devices. While the resource server 160 and the virtual assistant server 170 are shown separately in FIG. 1, in some implementations, the resource server 160 may include or otherwise be associated with the virtual assistant server 170. For example, various functions of the virtual assistant server 170 may be provided, at least in part, by the resource server 160, or vice versa. In particular, the resource server 160 may perform backend services of a virtual assistant server. Additionally, or alternatively, the virtual assistant server 170 may be a standalone computing system that is communicably connected to client devices executing a virtual assistant server.

The language model server 180 is configured to implement an AI system. In at least some implementations, the language model server 180 may host a large language model (LLM)-based chatbot, such as ChatGPT. The AI system uses one or more generative models to generate content. The generative model may be an unsupervised or semi-supervised machine learning algorithm that is trained using a set of training data content.

For example, the generative model may comprise an LLM that is based on transformer, a type of neural network architecture. The transformer architecture uses self-attention mechanisms in order to generate predicted output based on input data that has some sequential meaning (i.e., the order of the input data is meaningful, which is the case for most text input). A transformer may be trained on a text corpus that is labelled (e.g., annotated to indicate verbs, nouns, etc.) or unlabelled. Although transformer-based language models are described herein, it should be understood that the present disclosure may be applicable to other ML-based language models, including language models based on other neural network architectures such as recurrent neural network (RNN)-based language models.

LLMs may be trained on large data sets of unlabeled text. Some LLMs may be trained on a large multi-language, multi-domain corpus, to enable the model to be versatile at various language-based tasks, such as generative tasks (e.g., generating human-like responses to natural language input). Input prompts may be provided to the language model server 180, and the generative model may produce outputs related to the input prompts.

The client device 110, the resource server 160, the virtual assistant server 170, and the language model server 180 may be in geographically disparate locations. Put differently, the client device 110 may be remote from at least one of: the resource server 160, the virtual assistant server 170, and the language model server 180. As described above, each of the client device 110, the resource server 160, the virtual assistant server 170, and the language model server 180 may be computer systems.

The network 120 is a computer network. In some implementations, the network 120 may be an internetwork such as may be formed of one or more interconnected computer networks. For example, the network 120 may be or include an Ethernet network, an asynchronous transfer mode network, a wireless network, or the like.

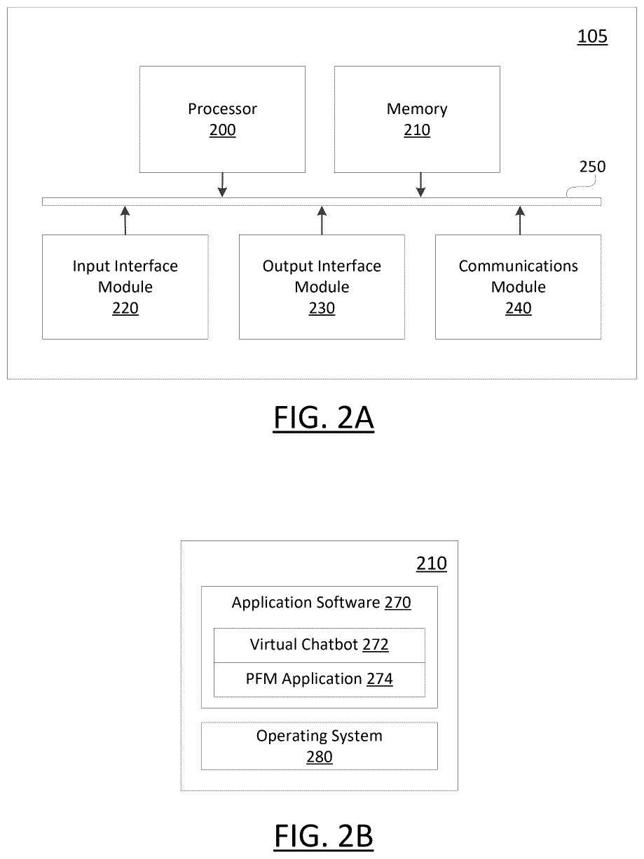

FIG. 2A is a high-level operation diagram of an example computing device 105. In some implementations, the example computing device 105 may be exemplary of one or more of: the client device 110, the web server 150, the resource server 160, the virtual assistant server 170, and the language model server 180. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. For example, the processor 200 may be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some implementations, all or a portion of the input interface module 220 may be integrated with an input device. For example, the input interface module 220 may be integrated with one of the aforementioned input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some implementations, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards.

For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some implementations, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated these software components include an operating system 280 and application software 270.

The operating system 280 is software. The operating system 280 allows the application software 270 to access the processor 200, the memory 210, the input interface module 220, the output interface module 230, and the communications module 240. The operating system 280 may be, for example, Apple iOS™, Google's Android™, Linux™, Microsoft Windows™, or the like.

The application software 270 adapts the example computing device 105, in combination with the operating system 280, to operate as a device performing particular functions. The application software 270 may, for example, comprise a resource allocation application. A resource allocation application may be used to define operations, tasks, or objectives associated with the client device 110 or a user of the client device 110, and to allocate various quantities of resources to the defined operations/tasks/objectives. The resource allocation application may, for example, be a job scheduler application for managing device operations, such as tasks and background services, and allocating quantities of computing resources to the device operations. A job scheduler may be used to control which tasks (e.g. applications) and background services are actively running on the client device 110, and to manage, in real-time, the allocation of computing resources to those tasks and services. For example, the job scheduler may allow users to define parameters for controlling the quantities of computing resources that can be consumed by individual tasks and services.

As another example, the resource allocation application may be a personal finance management (PFM) application. A PFM application allows users to track expenses, balances, and savings, and facilitates personal budgeting. In particular, a PFM application may be used to define various savings goals and set aside (or allocate) money toward those goals. A PFM application may maintain a list (“Wish List”) of savings goals defined by a user. The savings goals may be tied to a specific banking account. The PFM application may allow a user to select one of the user's banking accounts to connect to their list of savings goals. The PFM application allocates funds of the selected banking account to the user-defined savings goals. For example, the savings balance and future deposits in a selected savings account may be allocated to the user's savings goals based on one or more allocation rules (e.g. percentages, ratios, etc.) defined by the user. Users may be able to define relative percentages for allocating savings balance/deposits to different savings goals. The PFM application ensures that savings balance/deposits of the selected account are allocated according to the user-defined percentages.

A savings goal may be defined, via freeform text input or selection from a picklist of common or suggested goals. The GUI of a PFM application may enable a user to input various details about a savings goal (“Wish List Item”). In some embodiments, a picklist of goals may be generated based on personal data associated with a user of the PFM application. For example, the picklist may contain only those goals which are determined to be relevant for the user based on the user's personal information (e.g. age, marital status, employment status, etc.) and/or historical transactions data (e.g. past purchases, ongoing payments, etc.). The savings goals of the picklist may be presented in an order, or priority, which may also be determined based on the user's personal data. For example, a goal to save for a down-payment may be listed or ordered in the picklist with a higher priority for a user of a particular age but may be de-prioritized or excluded altogether for a user of a different age (i.e. an age that is not considered to be a first-time homebuying age).

A PFM application may allow users to define threshold quantities of resources associated with the selected savings goals. A threshold quantity may, for example, be a quantity of resources that is required to complete a particular savings goal. By way of example, if a savings goal is associated with a specific activity (e.g. vacation), the threshold quantity specified by the user may be an expected cost of performing the activity.

The resource allocation application may be a stand-alone application, such as a mobile app, or integrated into another application or software module resident on the example computing device 105 as a sub-function or feature. In some embodiments, features of the resource allocation application may be integrated into a personal banking application. For example, the resource allocation application may be a component of software for managing personal accounts on servers of a bank institution.

The resource allocation application is associated with a backend application server. In at least some embodiments, a resource server (such as resource server 160 of FIG. 1) may also serve as the backend application server for the resource allocation application. In particular, various functions of the resource allocation application may be provided, at least in part, by a resource server. For example, a server associated with a financial institution may perform backend services of the resource allocation application. Thus, the resource server may be configured to access personal finance information for a client, receive financial goals data from the client, determine initial allocation of resources to one or more financial goals, and configure re-allocations of resources or generate offers to lend additional resources to the client.

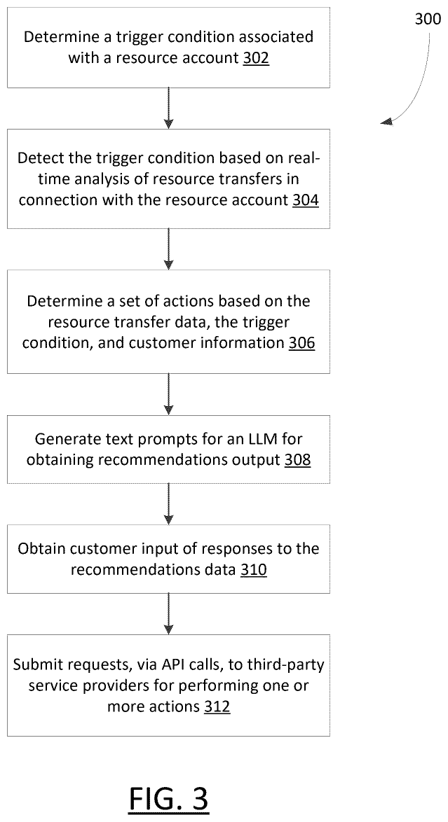

Reference is made to FIG. 3 which shows, in flowchart form, an example method 300 for processing account operations of a resource account. The operations of method 300 may be performed by a client device (e.g., by software resident on the client device), either alone or in conjunction with one or more computer servers. For example, a client device that is operable to execute a virtual assistant software module may perform one or more client-side operations of method 300 and a server, such as the virtual assistant server 170 of FIG. 1, that acts as a backend for a virtual assistant may perform certain server-side operations of method 300. In particular, computer-executable instructions stored in memory of a client computing device (or a server computer) may, when executed by a processor of the client computing device (or server), configure the processor to perform the operations of method 300.

An account owner of a resource account may define certain goals and/or trigger conditions in connection with their account. The goals may, for example, be financial goals or milestones, which may be specified using a PFM application. In operation 302, the processor determines at least one trigger condition associated with the resource account. In at least some implementations, the trigger conditions relate to a quantity of resources that are allocated to a user-defined goal for the resource account. The processor may, for example, receive user input of an indication of one or more user-defined goals and for each goal, a first quantity of resources of the resource account for allocating to the goal. The first quantity of resources may represent a threshold quantity for the respective goal. In particular, the first quantity may be a minimum quantity of resources which the user indicates to be required to be saved or otherwise allocated to the goal. The defined goals may be stored in association with database records of the resource account.

In operation 304, the processor detects the at least one trigger condition based on real-time analysis of resource transfers in connection with the resource account. For example, the processor may detect that a user-defined goal has been achieved as a result of completion of one or more transfer operations. In at least some implementations, the processor obtains historical transactions data associated with the resource account. The historical transactions data may include all or a subset of all previous transfer operations conducted in connection with the resource account. The processor is also configured to obtain and analyze real-time transfer operation data for the resource account. The processor determines that a first user-defined goal has been achieved based on the historical transactions data and real-time transfer operation data. In some implementations, the processor may parse the historical and real-time transfer operations data and identify resource transfers that relate to the user-defined goal. For example, the processor may parse descriptive text associated with a plurality of transactions in order to identify resource transfers that are relevant to the goal. By parsing the descriptive text, the processor may extract keywords associated with the transactions and determine, based on the extracted keywords, the relevance of each transaction to the defined goal.

In operation 306, the processor determines a set of actions based on the resource transfer data, the at least one trigger condition, and customer information of the customer. The customer information may comprise at least one of: profile information, personal preference data, or indications of budgeting patterns and spending behaviors. Each action of the set may comprise one or more steps or tasks that are to be performed in connection with a user-defined goal. In particular, for a detected goal, the processor may identify actions/tasks for enabling the goal to be achieved. The actions may include tasks that a virtual assistant can initiate using the goal and customer data. For example, the user-defined goal may be saving for a milestone (e.g., anniversary) or an otherwise planned or prospective event (e.g., vacation). In at least some implementations, the set of actions may include at least one of: obtaining itinerary or reservations data from a data store; obtaining product reviews data from a data store; or completing reservations on one or more third-party service provider platforms. The processor may determine a mapping of various goals (or goal types) to actions that are to be performed in connection with the goals. For example, a mapping of defined goal types to actions may be stored in memory that is accessible to the processor. Additionally, or alternatively, the processor may generate input prompts for a large language model (LLM) for querying the actions that are desired or necessary for completing the defined goal(s). The input prompts may indicate, for example, the goal data such as goal type (e.g., vacation), related details (e.g., date, destination, number of travelers, etc.), and a desired form of output specifying the actions that are required to complete the goal.

As part of performing the required tasks for the detected goal, the processor also generates input prompts for an LLM to obtain recommendations output for the customer in connection with one or more of the actions of the determined set (operation 308). In some implementations, the processor may generate the text prompts using information associated with the at least one trigger condition, such as budget, type of event or activities associated with the related goal, etc., and customer information (e.g., customer age, marital status, budgeting patterns, spending behaviors, personal preference data, etc.).

The output of the LLM may comprise recommendations for the customer and/or set of options that the customer would be prompted to select from. In operation 310, the processor obtains customer input of responses to the recommendations data. The customer-inputted responses may be received, for example, via a chat function provided by a virtual assistant that is executable on the client computing device. In some implementations, the customer-inputted responses may include at least selections of one or more desired itinerary items. The processor may then initiate reservations using the selected one or more itinerary items. In operation 312, the processor submits requests, via API calls, to one or more third-party service providers in order to perform the one or more actions. The API calls are generated based on the customer-inputted responses and formatted to comply with requirements for querying APIs associated with the third-party service providers. In particular, the API calls may include instructions and/or requests for the service providers to initiate one or more services based on parameters and selections that are inputted by the customer.

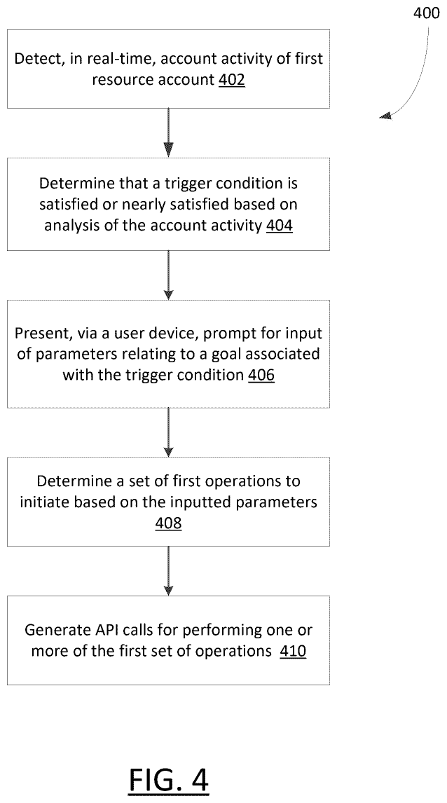

Reference is made to FIG. 4 which shows, in flowchart form, an example method 400 for processing computing operations that are driven by detected account activity of a resource account. The operations of method 400 may be performed by a client device (e.g., by software resident on the client device), either alone or in conjunction with one or more computer servers. For example, a client device that is operable to execute a virtual assistant software module may perform one or more client-side operations of method 400 and a server, such as the virtual assistant server 170 of FIG. 1, that acts as a backend for a virtual assistant may perform certain server-side operations of method 400. The operations of method 400 may be performed in addition to, or as alternatives of, one or more operations of method 300.

In operation 402, the processor detects, in real-time, account activity of a first resource account. The account activity may comprise real-time transfer operations, such as deposit or withdrawal operations, for the first resource account. In operation 404, the processor determines that a trigger condition is satisfied or nearly satisfied based on analysis of the account activity. A trigger condition may be detected, for example, if the processor determines that a transfer operation results in an allocation or total balance of resources that satisfy some defined threshold-based requirement for a user-defined goal. That is, the determination of whether a trigger condition is satisfied depends on comparing a current allocation or balance of resources of a resource account to one or more relevant thresholds associated with user-defined goals.

In at least some implementations, the processor may determine that completion of a first user-defined goal is imminent based on historical and real-time transfer operations data associated with the first resource account. For example, the processor may detect proximity to at least one of a user-inputted defined goal date or quantity of allocated resources (i.e., defined threshold quantity) associated with the goal. The “proximity” can be gauged by, for example, determining a difference between the goal date/quantity and current values of date/allocated quantity (i.e., resulting from past and real-time detected transfer operations), and comparing said difference with predefined proximity indicating thresholds. The processor may generate notifications for alerting a user associated with the first resource account regarding the imminent completion.

In operation 406, the processor presents, via the user device, a prompt for input of parameters relating to a goal associated with the trigger condition. More particularly, the processor is configured to prompt customers to provide input defining one or more desired parameters for the goal, such as a milestone or planned/prospective event. The desired parameters represent a customer's indication of specific details or minimum requirements for the goal. The processor determines a set of first operations to initiate based on the inputted parameters, in operation 408. In some implementations, the first operations may be determined by the processor by providing, as input to an LLM-based chatbot, the parameters inputted by the customer. The LLM input may, for example, include an indication of minimum requirements as specified by the customer and a request to generate output that includes details of operations/actions that should be conducted. In operation 410, the processor generates API calls for performing one or more of the first set of operations.

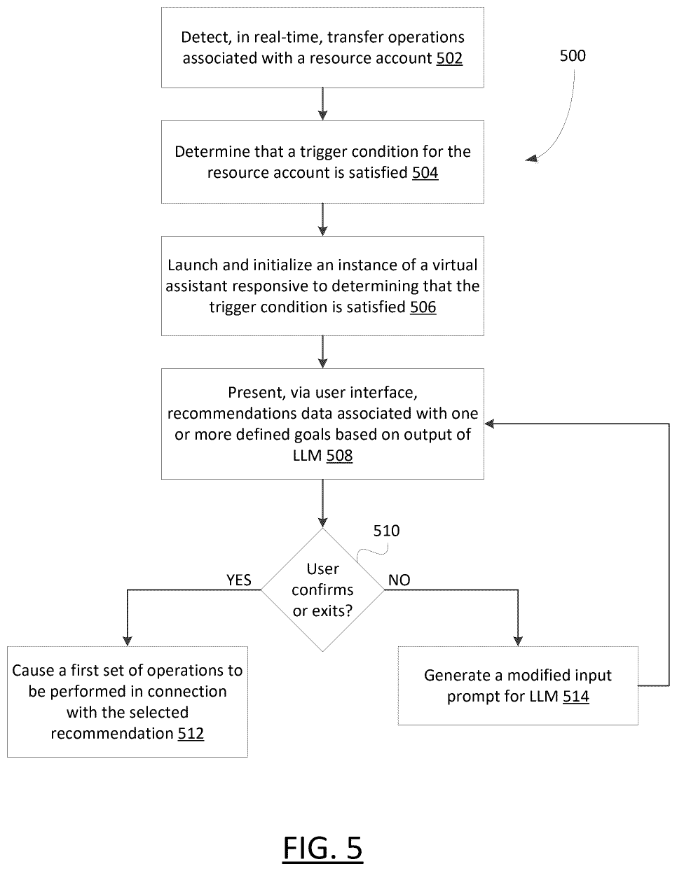

Reference is made to FIG. 5 which shows, in flowchart form, an example method 500 for operating a virtual assistant application to process computing operations that are driven by detected account activity of a resource account. The operations of method 500 may be performed by a client device (e.g., by software resident on the client device), either alone or in conjunction with one or more computer servers. For example, a client device that is operable to execute a virtual assistant software module may perform one or more client-side operations of method 500 and a server, such as the virtual assistant server 170 of FIG. 1, that acts as a backend for a virtual assistant may perform certain server-side operations of method 500. The operations of method 500 may be performed in addition to, or as alternatives of, one or more of the operations of methods 300 and 400.

In operation 502, the processor detects, in real-time, transfer operations associated with a resource account. The transfer operations may include deposit or withdrawal operations for the resource account. More generally, the transfer operations are those transfers that result in changes to a total balance of a quantity of resources associated with the resource account. In operation 504, the processor determines that a trigger condition for the resource account is satisfied. As described above, a trigger condition may relate to a quantity of allocated or saved resources in connection in connection with a user-defined goal. The determination of whether a trigger condition is satisfied may require comparing the quantity of allocated/saved resources to some defined threshold quantity specified by the user. The threshold quantity may, for example, represent a minimum quantity of resources that is required/desired for the associated goal.

The processor launches and initializes an instance of a virtual assistant responsive to determining that the trigger condition is satisfied, in operation 506. In particular, once the processor determines that a threshold quantity of resources associated with a goal has been exceeded, the virtual assistant may be launched on the client computing device. The virtual assistant is configured to facilitate chat-based communications between the customer and an LLM server that forms the backbone of a query engine for the processor.

In operation 508, the processor presents, via the user interface, recommendations data associated with one or more defined goals based on output of a large language model (LLM). The virtual assistant facilitates interactions with the LLM by enabling customers to provide indications of desired parameters for the detected goal(s) (for example, via a chat function of an LLM-based chatbot) and to access output of the LLM that specifies, at least, recommendations data in connection with the customer's goals. The LLM output may be obtained in a similar manner as described above with respect to methods 300 and 400.

If, in operation 510, the user provides confirmation or exits, the processor causes a first set of operations to be performed in connection with the selected recommendation (operation 512). The confirmation or exit is a proxy for the customer's indication that the selected recommendations are satisfactory and that the query for information can be terminated. On the other hand, if the user does not provide confirmation, the processor generates a modified input prompt for the LLM, in operation 514. The modified input prompt may be different in at least one aspect from the previous input to the LLM containing the customer's preferences and/or minimum requirements.

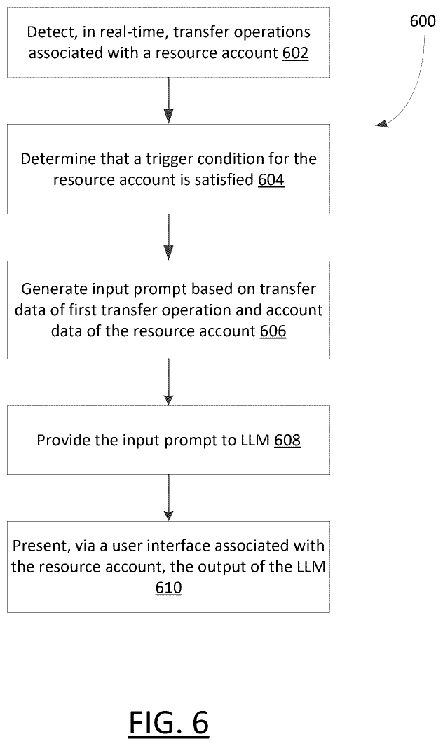

Reference is made to FIG. 6 which shows, in flowchart form, an example method 600 for converting account activity data of a resource account to executable computing operations. The operations of method 600 may be performed by a client device (e.g., by software resident on the client device), either alone or in conjunction with one or more computer servers. For example, a client device that is operable to execute a virtual assistant software module may perform one or more client-side operations of method 600 and a server, such as the virtual assistant server 170 of FIG. 1, that acts as a backend for a virtual assistant may perform certain server-side operations of method 600. The operations of method 600 may be performed in addition to, or as alternatives of, one or more of the operations of methods 300 to 500.

In operation 602, the processor detects, in real-time, transfer operations associated with a resource account. The transfer operations may include deposit or withdrawal operations for the resource account. More generally, the transfer operations are those transfers that result in changes to a total balance of a quantity of resources associated with the resource account.

In operation 604, the processor determines that a trigger condition for the resource account is satisfied. A trigger condition may relate to a quantity of allocated or saved resources in connection in connection with a user-defined goal. The determination of whether a trigger condition is satisfied may require comparing the quantity of allocated/saved resources to some defined threshold quantity specified by the user.

In operation 606, the processor generates an input prompt based on transfer data of first transfer operation and account data of the resource account. In at least some implementations, the transfer data may include a quantity of resources transferred, an identifier of a transferor, and a time of the transfer operation. The account data may include, at least, a total balance of resources for the resource account. The input prompt may comprise a request to generate recommendations for actions/tasks relating to the detected trigger condition. In operation 608, the processor provides the input prompt to a large language model. The processor then presents, via a user interface associated with the resource account, the output of the LLM (operation 610).

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above.

In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor,
a memory coupled to the processor, the memory storing computer-executable instructions that, when executed by the processor, configure the processor to:
determine at least one trigger condition associated with a resource account;
detect the at least one trigger condition based on real-time analysis of resource transfers in connection the resource account;
determine a set of actions based on the resource transfer data, the at least one trigger condition, and customer information;
generate text prompts for a large language model to obtain recommendations output in connection with one or more of the actions of the determined set;
obtain input of responses to the recommendations data; and
submit requests, via API calls, to one or more third-party service providers in order to perform the one or more actions, the API calls being generated based on the inputted responses.

2. The computing system of claim 1, wherein the at least one trigger condition relates to a quantity of resources that are allocated to a user-defined goal for the resource account.

3. The computing system of claim 2, wherein the instructions, when executed, further configure the processor to receive user input of an indication of the user-defined goal and a first quantity of resources of the resource account for allocating to the goal.

4. The computing system of claim 1, wherein the customer information comprises at least one of profile information, personal preference data, or indications of budgeting patterns and spending behaviors.

5. The computing system of claim 1, wherein the set of actions includes at least one of:
obtaining itinerary or reservations data from a first data store;
obtaining product reviews data from a second data store; or
completing reservations on one or more third-party service provider platforms.

6. The computing system of claim 1, wherein detecting the at least one trigger condition comprises:
obtaining historical transactions data associated with the resource account; and
determining that a first user-defined goal has been achieved based on the historical transactions data.

7. The computing system of claim 6, wherein the instructions, when executed, further configure the processor to parse the historical transactions data and identify one or more resource transfers that relate to the first user-defined goal.

8. The computing system of claim 1, wherein the customer-inputted responses comprise at least selections of one or more desired itinerary items, and wherein the instructions, when executed, further configure the processor to initiate reservations using the selected one or more itinerary items.

9. The computing system of claim 1, wherein the instructions, when executed, further configure the processor to:
determine that completion of a first user-defined goal is imminent based on historical transactions data associated with the resource account; and
generate notifications for alerting a user associated with the resource account regarding the imminent completion.

10. The computing system of claim 9, wherein determining that completion of the first user-defined goal is imminent comprises detecting proximity to at least one of a user-inputted defined date or quantity of allocated resources.

11. A computer-implemented method, comprising:
determining at least one trigger condition associated with a resource account;
detecting the at least one trigger condition based on real-time analysis of resource transfers in connection the resource account;
determining a set of actions based on the resource transfer data, the at least one trigger condition, and customer information;
generating text prompts for a large language model to obtain recommendations output in connection with one or more of the actions of the determined set;
obtaining input of responses to the recommendations data; and
submitting requests, via API calls, to one or more third-party service providers in order to perform the one or more actions, the API calls being generated based on the inputted responses.

12. The method of claim 11, wherein the at least one trigger condition relates to a quantity of resources that are allocated to a user-defined goal for the resource account.

13. The method of claim 12, further comprising receiving user input of an indication of the user-defined goal and a first quantity of resources of the resource account for allocating to the goal.

14. The method of claim 11, wherein the customer information comprises at least one of profile information, personal preference data, or indications of budgeting patterns and spending behaviors.

15. The method of claim 11, wherein the set of actions includes at least one of:
obtaining itinerary or reservations data from a first data store;
obtaining product reviews data from a second data store; or
completing reservations on one or more third-party service provider platforms.

16. The method of claim 11, wherein detecting the at least one trigger condition comprises:
obtaining historical transactions data associated with the resource account; and
determining that a first user-defined goal has been achieved based on the historical transactions data.

17. The method of claim 16, further comprising parsing the historical transactions data and identifying one or more resource transfers that relate to the first user-defined goal.

18. The method of claim 11, wherein the customer-inputted responses comprise at least selections of one or more desired itinerary items, and wherein the method further comprises initiating reservations using the selected one or more itinerary items.

19. The method of claim 11, further comprising:
determining that completion of a first user-defined goal is imminent based on historical transactions data associated with the resource account; and
generating notifications for alerting a user associated with the resource account regarding the imminent completion.

20. The method of claim 19, wherein determining that completion of the first user-defined goal is imminent comprises detecting proximity to at least one of a user-inputted defined date or quantity of allocated resources.
